(19) United States
(12) Patent Application Publication
(10) Pub. No.: US 2026/0149408 A1
(43) Pub. Date: May 28, 2026

(54) Topologically Optimized Reinforcement For Photovoltaic (PV) Module Frames for Cell Crack Reduction Against Extreme Weather Conditions

(71) Applicant: UNM RAINFOREST INNOVATIONS, Albuquerque, NM (US)

(72) Inventors: Sang M. HAN, Albuquerque, NM (US); Leonid MIROSHNIK, Albuquerque, NM (US)

(73) Assignee: UNM RAINFOREST INNOVATIONS, Albuquerque, NM (US)

(21) Appl. No.: 19/177,774

(22) Filed: Apr. 14, 2025

Related U.S. Application Data
(60) Provisional application No. 63/634,963, filed on Apr. 17, 2024.

(51) Int. Cl. H02S 30/10

(52) U.S. Cl. CPC H02S 30/10

(57) ABSTRACT

A reinforcement frame includes a modular frame having one or more supporting structural beams, and a topologically optimized reinforcement portion intersecting with the one or more supporting structural beams. Implementations of the reinforcement frame can include where the modular frame may include a metal, a metal alloy, or a combination thereof, such as aluminum, steel or a combination thereof. The modular frame further may include a material having a glass transition temperature equal or greater to about 100° C. The modular frame may include a polymer, a fiber-reinforced polymer or a combination thereof. The topologically optimized reinforcement portion may include a material having high emissivity in a mid-infrared range. The topologically optimized reinforcement portion further may include a material having a glass transition temperature equal or greater to about 100° C. A method of optimizing a module frame reinforcement is also disclosed.

### CROSS-REFERENCE TO RELATED APPLICATIONS

This application claims the benefit of U.S. Provisional Patent Application No. 63/634,963, filed on Apr. 17, 2024, which is hereby incorporated by reference in its entirety.

### STATEMENT OF GOVERNMENT INTEREST

This invention was made with government support under DE-AC36-08GO28308 awarded by the Department of Energy. The government has certain rights in the invention.

### TECHNICAL FIELD

The present teachings relate generally to the field of reinforcement frames for photovoltaic (PV) modules, and more particularly to providing topologically optimized reinforcement for photovoltaic (PV) module frames for damage protection in exposure to environmental stressors such as mechanical load, wind, precipitation, heat, and cold, as well as extreme weather conditions such as hailstorms, hurricanes, and tornadoes.

### BACKGROUND

Damages to photovoltaic (PV) modules and trackers often occur during extreme weather events. As these damages can be costly, PV asset management against extreme weather events has become a major concern for PV project developers and field owners, particularly, in the affected areas. As one example, the hail damage to a solar project in west Texas in 2019 alone cost $75M in insured loss. With increasing frequency and cost associated with these types of damage, these assets are becoming non-insurable or insurable at a much higher cost.

While some of the damages from extreme weather events are irrecoverable, requiring module replacement and tracker repair, some damage may be recoverable or can be mitigated to maintain power generation. One instance is cell cracks. Cracks appearing in solar cells can lead to power loss over time. As extreme weather events, such as hailstorms and hurricanes, become frequent, the PV industry anticipates cell cracks to significantly add to module degradation in the future. Another example is glass cracks for large ‘floppy’ modules that are on the market today. The use of thin heat-treated glass for large module construction, mounting of these large ‘floppy’ modules on trackers, and manufacturing flaws in edge seal and framing can lead to premature glass breakage and module failure.

Therefore, it is desirable to design and fabricate improved reinforcement methods and apparatus for pre-existing and new PV module frames against extreme weather events, such as hurricanes and hailstorms.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A reinforcement frame is disclosed. The reinforcement frame includes a modular frame having one or more supporting structural beams, and a topologically optimized reinforcement portion intersecting with the one or more supporting structural beams. Implementations of the reinforcement frame can include where the modular frame may include a metal, a metal alloy, or a combination thereof. The modular frame may include aluminum, steel or a combination thereof. The modular frame further may include a material having a glass transition temperature equal or greater to about 100° C. The modular frame may include a polymer, a fiber-reinforced polymer or a combination thereof. The topologically optimized reinforcement portion may include a metal, a metal alloy, or a combination thereof. The topologically optimized reinforcement portion may include a polymer, a fiber-reinforced polymer or a combination thereof. The topologically optimized reinforcement portion may include a material having high emissivity in a mid-infrared range. The topologically optimized reinforcement portion further may include a material having a glass transition temperature equal or greater to about 100° C.

A method of optimizing a module frame reinforcement is disclosed and can include creating a topological map of a reinforcement in a module frame, determining one or more pressure values over the topological map at a prescribed load, optimizing one or more locations in the reinforcement corresponding to the one or more pressure values, and redesigning the reinforcement to incorporate support in the one or more locations in the reinforcement corresponding to the one or more pressure values in a topologically optimized module frame. Other examples of this aspect include corresponding computer systems, apparatus, and computer programs recorded on one or more computer storage devices, each configured to perform the actions of the methods.

Implementations of the method include where the prescribed load is 2400 Pa. The prescribed load can be 5000 Pa. The method may include fabricating a topologically optimized module frame. The method may include incorporating the topologically optimized module frame into a photovoltaic module. The topologically optimized module frame may include a polymer, a fiber-reinforced polymer or a combination thereof. The method may include injection molding a topologically optimized module frame. The topologically optimized module frame may include use of a polymer, a fiber-reinforced polymer or a combination thereof. The topologically optimized module frame can include a metal, a metal alloy, or a combination thereof. The method may include 3D printing a topologically optimized module frame. The topologically optimized module frame can include a polymer, a fiber-reinforced polymer or a combination thereof.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIGS. 1A-1C are representative of photovoltaic (PV) module arrays in a utility scale solar farm, an existing reinforcement support design, and a topologically optimized reinforcement support design, respectively, in accordance with the present disclosure.

FIGS. 2A-2H are a series of views of a reinforcement support design, illustrating a method and workflow of topologically optimizing the reinforcement support design, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present disclosure provides a method to reinforce pre-existing as well as new PV module frames against extreme weather events, such as hurricanes and hailstorms and a resulting topologically optimized reinforcement support design or module frame.

For the purposes of the present teachings, topology optimization can refer to a mathematical method used to find the optimal distribution of material within a defined domain, aiming to minimize material usage and/or strain energy while maintaining structural strength. While often used in conjunction with 3D printing, the concept can be applied or expanded to any number of construction or fabrication methods, as well as a multitude of applications.

Topology optimization can be utilized to find the best possible arrangement of material within a given design space or set of parameters to achieve a specific objective, such as minimizing weight or maximizing stiffness. In examples of the present disclosure, providing a support design or module frame for photovoltaic (PV) modules and trackers is a primary goal. Topological optimization focuses on how material is distributed, rather than just the overall shape or size of the structure. Upon definition of one or more design variables, such as, but not limited to material density, materials stiffness, material placement, and the like, within each element of a mesh, or one or more cost functions, including, for example, structural compliance that can be minimized or maximized according to the design constraints.

Topological optimization can further consider other constraints, such as manufacturing limitations or required performance characteristics, to ensure the resulting design is feasible and functional. Complex shapes or structures generated by topological optimization can be well-suited for fabrication using additive manufacturing techniques like 3D printing, which allows for the creation of parts with intricate geometries that are difficult or impossible to produce using traditional methods, other fabrication methods, such as metal stamping, casting, or more conventional fabrication methods, or combinations thereof can also be employed.

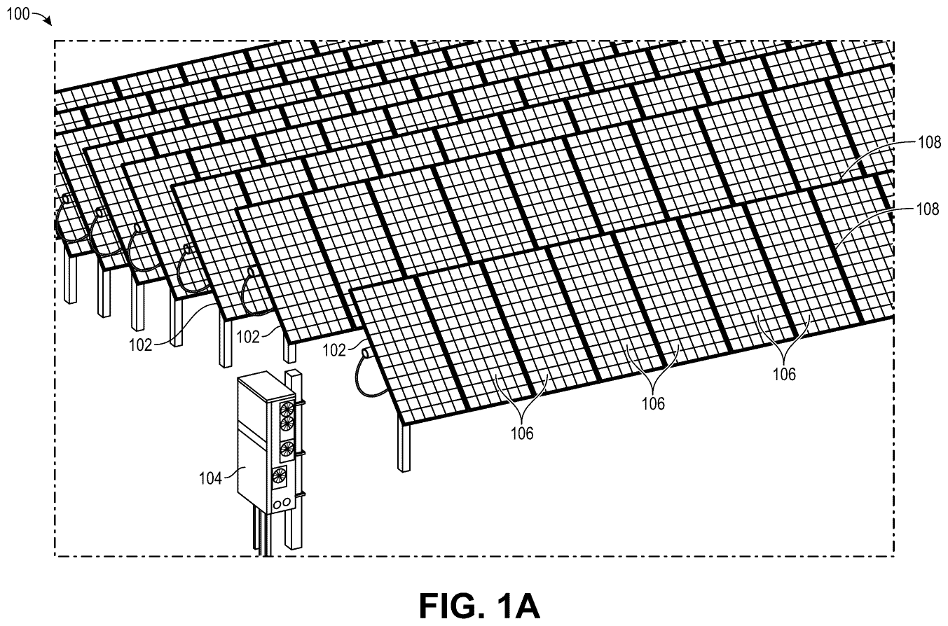

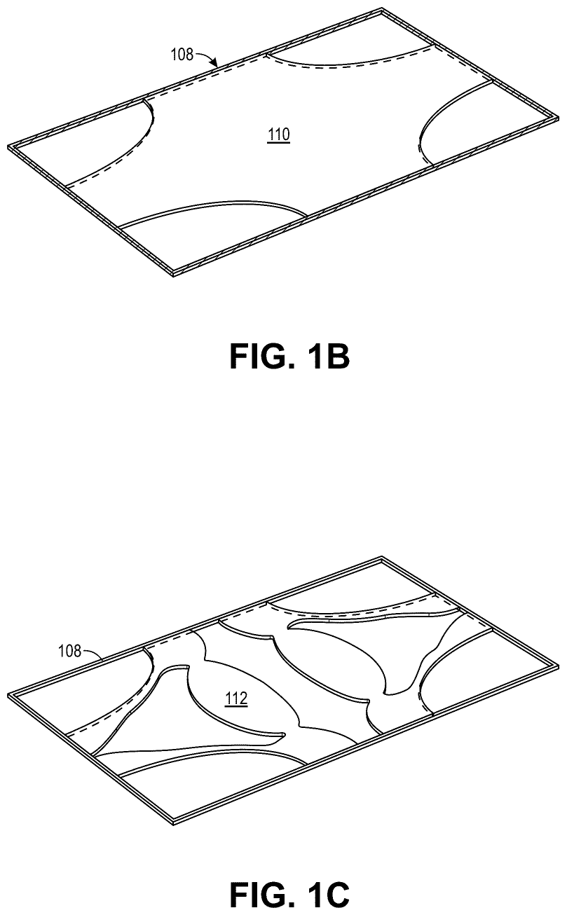

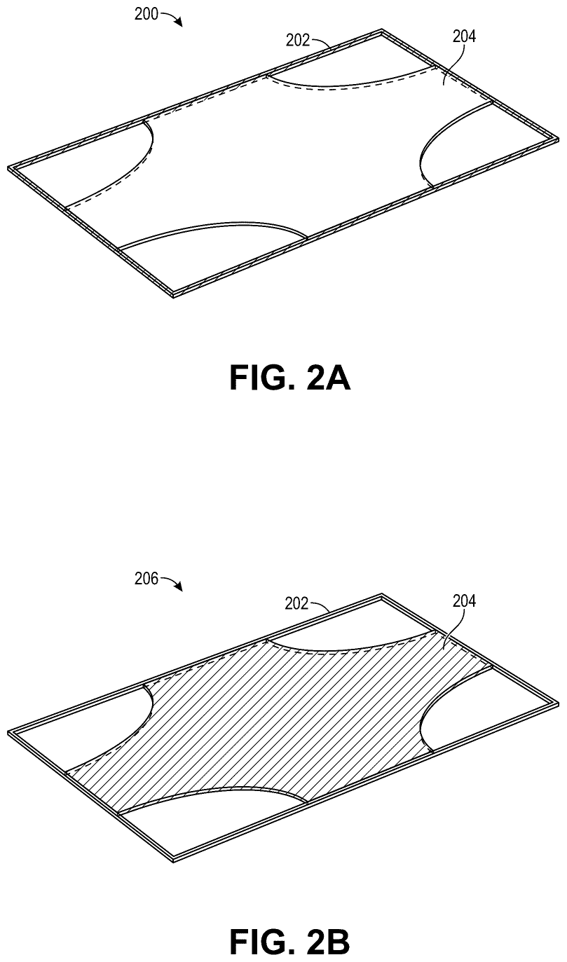

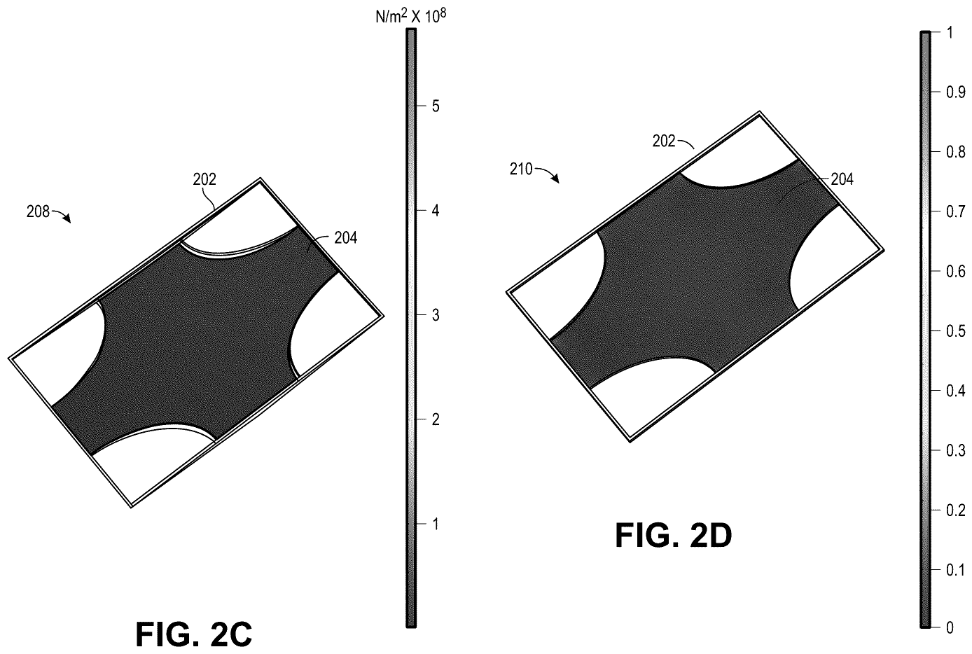

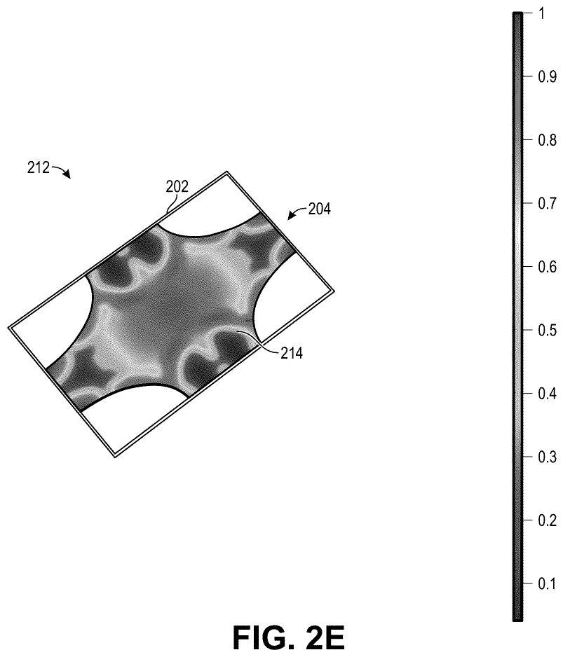

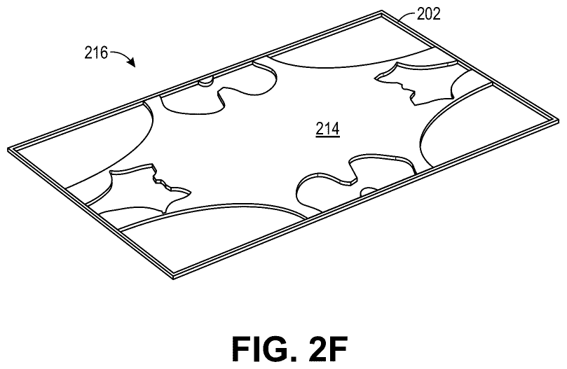

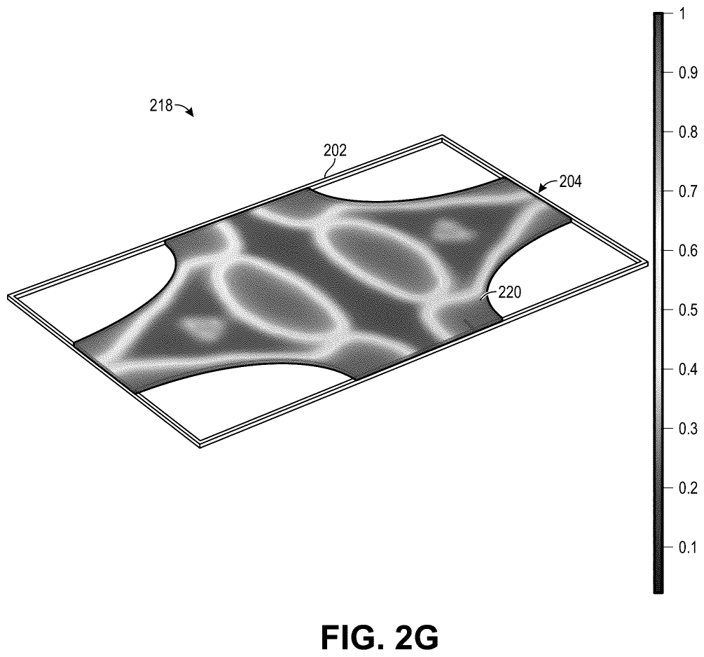

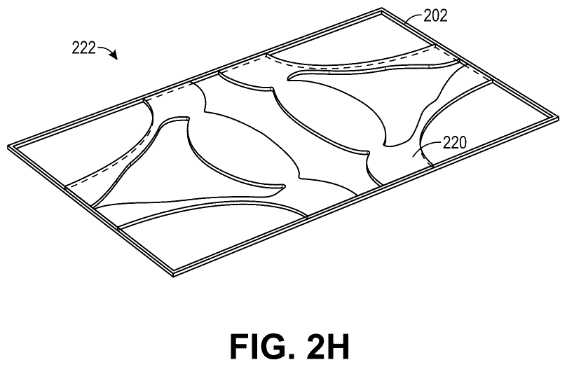

Disclosed is a method to reinforce pre-existing as well as new PV module frames against extreme weather events, such as hurricanes and hailstorms and a resulting topologically optimized reinforcement support design or module frame. A modular frame with one or more supporting structural beams and a topologically optimized reinforcement portion is a design that offers useful advantages over traditional reinforcement methods in photovoltaic (PV) module frames. This design has a modular frame made from materials such as metal (e.g., aluminum, and steel) or polymers with fibers to increase its strength. The portion of the topologically optimized frames (e.g., 112 in FIGS. 1C, 204 in FIGS. 2A, 214 in FIG. 2F, and 220 in FIG. 2H) can also be optically transparent, high-strength plastics, such as polycarbonate, polymethylmethacrylate, acrylic, and polyethylene terephthalate, to accommodate bifacial PV modules, where light is absorbed from both the front and back of the PV module. The topologically optimized reinforcement portion intersects with the beams and is configured to improve structural stability and resistance to damage.

The optimization process accounts for stress distribution, in response to external mechanical and thermal loading, and material properties to create stronger and lighter structures compared to traditional design methods. This approach results in a more efficient and effective design process that leads to improved performance and durability of the PV module frame. The topologically optimized reinforcement portion provides better structural stability and resistance to damage compared to traditional methods, resulting in improved performance and durability of the PV module frame.

The modular frame can be customized with various fabrication techniques, such as injection molding or 3D printing using materials like polymers, fiber-reinforced polymers, metals, metal alloys, or a combination thereof. The use of recyclable materials in the reinforcement support helps to minimize waste and promote sustainability in the manufacturing process.

The modular frame, including one or more supporting structural beams and topologically optimized reinforcement portion, can be applied to other types of structures besides PV module frames. The optimization process accounts for different loading patterns and boundary conditions by varying the design parameters accordingly. There are no limitations or constraints on the design that need to be considered during the optimization process. The optimized locations are then reconfigured to incorporate support, resulting in a topologically optimized reinforcement portion that improves structural stability and resistance to damage compared to traditional reinforcement methods. What bounds the optimized design includes nodal points (i.e., fixed boundaries, such as the rectangular module frame at the perimeter), maximum load that can be applied to the module, maximum stress that can be tolerated, and desired reduction in materials cost.

The modular frame can be made from materials such as metal (e.g., aluminum and steel), or polymers that offer high strength-to-weight ratios and good durability in extreme weather conditions. The use of fibers in the modular frame can increase frame strength as compared to frames made without fibers by adding reinforcement and stiffness to the structure. Different types of fibers affect the mechanical properties and performance of the reinforcement portion by influencing its strength, stiffness, and durability in extreme weather conditions. For example, carbon fiber reinforced polymers (CFRP) or glass fiber reinforced polymers (GFRP) can be used to enhance the mechanical properties of the material. The portion of the topologically optimized frames (e.g., 112 in FIGS. 1C, 204 in FIGS. 2A, 214 in FIG. 2F, and 220 in FIG. 2H) can also be optically transparent, high-strength plastics, such as polycarbonate, polymethylmethacrylate, acrylic, and polyethylene terephthalate, to accommodate bifacial PV modules, where light is absorbed from both the front and back of the PV module.

The topologically optimized reinforcement portion can also be made from these materials or other materials that have high emissivity in the mid-infrared range or a glass transition temperature equal to or greater than 100° C. Materials with a glass transition temperature equal or greater than 100° C. include thermoplastics, such as polyethylene, polypropylene, and polystyrene. The glass transition temperature affects the performance of the reinforcement portion by determining its durability and resistance to deformation in extreme weather events. Materials with high emissivity in the mid-infrared range include certain metals, such as copper or aluminum, which can reflect infrared radiation and help reduce the module operating temperature by radiative cooling. These materials can reflect infrared radiation and help increase radiative cooling, which is functional for maintaining structural stability under high temperatures. The modular frame used for the optimizations of the present disclosure can be made from various materials such as metal (e.g., aluminum and steel) or polymers, including fiber-reinforced polymers. Incorporating fibers into the modular frame increases its strength and stiffness while maintaining its lightweight nature. The topologically optimized reinforcement portion is configured to take into account stress distribution, in response to external mechanical and thermal loading, and material properties to create stronger and lighter structures, resulting in improved performance and durability of the PV module frame.

The method of the present disclosure is applicable to other types of structures besides PV module frames, as it accounts for different loading patterns and boundary conditions by varying the design parameters accordingly. The optimization process can also be adapted to suit specific requirements and constraints of each application, such as incorporating materials with high emissivity in the mid-infrared range or a glass transition temperature equal to or greater than 100° C. for thermal management or high-temperature resistance. In examples, the material having a glass transition temperature equal or greater than 100° C. contributes to the performance and durability of the topologically optimized reinforcement portion used in the modular frame for PV module frames. This type of material is valuable for withstanding extreme weather events such as hailstorms and hurricanes, which can cause damage to solar panel systems. The glass transition temperature refers to the temperature at which a thermoplastic material changes from a hard and brittle state to a more pliable and ductile one. Materials with a glass transition temperature equal or greater than 100° C. are known for their high durability and resistance to deformation, making them ideal for use in reinforcement portions of PV module frames. The use of materials with a high glass transition temperature also offers advantages in the fabrication process by allowing for precise control over the shape and structure of the reinforcement support. These techniques also enable the use of a wide range of materials, including polymers, fiber-reinforced polymers, metals, metal alloys, or combinations thereof, to create customized and optimized designs for specific applications.

Incorporating these and other materials into the design process allows for customization based on specific requirements and constraints, resulting in improved performance and durability of the PV module frame. The optimization process can account for different loading patterns and boundary conditions by varying the design parameters accordingly, ensuring that the reinforcement portion is tailored to meet the specific needs of each application, design, or specific structure.

The reinforcement support can be made from recyclable materials to reduce environmental impact. The use of recyclable materials helps to minimize waste and promote sustainability in the manufacturing process. Injection molding and 3D printing offer advantages in the fabrication process by allowing for precise control over the shape and structure of the reinforcement support. These techniques also enable the use of a wide range of materials, including polymers, fiber-reinforced polymers, metals, metal alloys, or combinations thereof, as well as other applicable materials described herein, to create customized and optimized designs for specific applications. The use of the aforementioned advanced manufacturing techniques allows for precise control over the shape and structure of the reinforcement support, enabling the creation of customized and optimized designs for specific applications.

### Polymer or Fiber-Reinforced Polymer Materials for Reinforcement

Polymers, including fiber-reinforced polymers (FRP), are a well-known choice for reinforcing the modular frames in photovoltaic module frames due to their high strength-to-weight ratios and good durability in extreme weather conditions. Polymers are a class of materials composed of repeating structural units called monomers, which can be synthesized from various precursors such as natural gas or petroleum products. FRPs are composite materials made by reinforcing polymers with fibers, typically glass, carbon, or aramid fibers, to enhance their mechanical properties and performance.

The use of polymer or fiber-reinforced polymer materials in an example of a modular frame can offer several advantages over traditional reinforcement methods. The incorporation of fibers into the polymer matrix increases its strength and stiffness while maintaining its lightweight nature, resulting in improved structural stability and resistance to damage. FRPs also offer excellent durability and resistance to environmental factors such as UV radiation, moisture, and temperature fluctuations, making them suitable for use in harsh outdoor environments.

In addition to their mechanical properties, polymer materials or fiber-reinforced polymer materials can be tailored to have specific emissivity ranges or glass transition temperatures, allowing for customization of the design to meet the requirements of each application. For example, mid-infrared emissivity can be incorporated into the material to enhance thermal management and increase radiative cooling in extreme weather events, while a high glass transition temperature can improve the resistance to deformation under high temperatures.

The topologically optimized reinforcement portion made from polymer materials or fiber-reinforced polymer materials offers improved structural stability and resistance to damage compared to traditional reinforcement methods. The method takes into account stress distribution, in response to external mechanical and thermal loading, and material properties to create stronger and lighter structures, resulting in improved performance and durability of the PV module frame. Incorporating fibers into the modular frame increases its strength and stiffness while maintaining its lightweight nature, allowing for increased structural stability and resistance to damage.

Reinforcement Portion with High Emissivity in Mid-Infrared Range: The reinforcement portion of the topologically optimized module frame can be further enhanced by incorporating a material having high emissivity in the mid-infrared range or in the ultraviolet range. This design feature offers several advantages for PV modules exposed to extreme weather events, such as extreme heat under direct sunlight. The reinforcement portion made of this material can help reduce the operating temperature of the PV modules by radiative cooling and maintain structural stability under high temperatures. By reflecting infrared radiation with high IR reflectivity, the material can also assist in dissipating heat and preventing cell cracks that may lead to power loss over time. This design feature is particularly beneficial for PV projects located in regions with frequent extreme weather events, as it helps mitigate damages that are otherwise costly or irrecoverable.

When selecting a material with high emissivity in the mid-infrared range or the ultraviolet range, several criteria should be considered to ensure optimal performance and durability of the reinforcement portion. Firstly, the composite material should have a glass transition temperature equal to or greater than 100° C., as this will determine its resistance to deformation under extreme weather conditions. Secondly, the material can also have high thermal conductivity to efficiently dissipate heat and maintain structural stability. Thirdly, it is useful to consider the cost of the material to ensure that it fits within the budget constraints of PV modules.

FIGS. 1A-1C are representative of photovoltaic (PV) module arrays in a utility scale solar farm, an existing reinforcement support design, and a topologically optimized reinforcement support design, respectively, in accordance with the present disclosure. The methodological approach to addressing cell crack and glass crack mitigation, according to the present disclosure, is to reinforce the PV module frame with a low-cost topologically optimized support. FIG. 1A shows the general shape and array of photovoltaic (PV) panels 106 as arranged within a solar farm 100. Each solar array 102 within the solar farm 100 includes multiple photovoltaic (PV) panels 106, whose rectangular frames 108 are mounted on fixed-tilt, single-axis, or dual axis-trackers. Attached to each solar array 102 is an inverter 104, which can be used to convert the direct current (DC) power into alternating current (AC). FIG. 1B shows an existing, or initial support design (i.e., initial condition before topological optimization) used to reinforce the frame 108. The support design 110 or support structure may not necessarily be specifically optimized for the stressors to which the frame 108 is exposed during operation, which can be based on weather-related or time-based exposure factor such as wind, UV degradation, precipitation, and the like. FIG. 1C shows the support design after topological optimization 112. In this case, the support design 112 is optimized against 2400 Pa front loading, and it is expected that the optimized design would vary depending on the loading pattern (i.e., loading boundary conditions). The reinforcement support may be made of optically transparent low-cost plastic or metal. One example is injection-molded or 3D-printed low-cost acrylic material. The acrylic support can be fiber-reinforced, UV-resistant, and can be engineered to have a relatively high glass transition temperature. If mid-infrared emissivity and module operation temperature are an issue, other polymer materials with high mid-infrared emissivity can be considered. Metals, such as aluminum and steel, can also be considered in certain embodiments such as monofacial PV modules.

Typical module size of PV panels of the present disclosure can range from about 1 m to about 3 m or from about 1 m to about 2.7 m. These larger modules are referred to as ‘floppy modules.’ As such, the modules are flexible and tend to sag and break, with glass breakage and the cracks in photovoltaic solar cells being a reliability issue associated with frame design. Therefore, frame and support structure materials are typically comprised of aluminum or steel. In some examples, this can include less expensive or low-grade steel. In other examples, steel alloy frames and modules including anti-corrosive coatings can be used. In still other examples, recycled steel materials or other steel materials including zinc-aluminum-magnesium coatings can be used, and in some cases will perform better than aluminum by the metrics and criteria as described herein. Most common materials for frames or support structures include aluminum or steel with weather resistant coatings, such as zinc (Zn), aluminum (Al), magnesium (Mg), or combinations thereof, as an alternative frame material.

The present disclosure provides an optimized module frame reinforcement method that involves creating a topological map of optimized reinforcement within a module frame, determining stress values over the topological map at a prescribed load, optimizing locations in the reinforcement corresponding to the determined pressure values, and redesigning the reinforcement to incorporate support in the optimized locations. The modular frame can be made from various materials such as metal (e.g., aluminum and steel), metal alloys, polymers, including fiber-reinforced polymers, or a combination thereof. This design allows for increased structural stability and resistance to damage compared to traditional reinforcement methods. The topologically optimized reinforcement portion improves the overall performance and durability of the PV module frame by taking into account stress distribution and material properties to create stronger and lighter structures.

FIGS. 2A-2H are a series of views of a reinforcement support design, illustrating a method and workflow of topologically optimizing the reinforcement support design, in accordance with the present disclosure. FIG. 2A depicts a schematic of a photovoltaic (PV) panel 200. Each photovoltaic (PV) panel 200, is held on a frame 202. The frame includes an existing, or initial support structure 204 used to reinforce the frame 202. FIG. 2B depicts a load applied photovoltaic (PV) panel 206. In the present method, a load is applied to the entire module within frame 202 and support structure 204, for example, by applying pressure to panel 206 mounted on a suction or pressurized fixture formed in a rectangular shape. The load can also be applied by mechanical actuators. All four edges of the panel 206, in particular around the frame 202, are aligned to and mounted on the edges of the suction/pressurized fixture. The edges are pneumatically sealed, thereby generating a pressure on the support structure 204 in a range of about 2500 Pa to about 5000 Pa. During this pressure application, the frame does not move, but the support structure 204 is pressured over the range, and may flex in response. FIG. 2C depicts a PV panel 208 and its response to the pressure described previously. The stress generated in the frame 202 and support structure 204 of the panel 208 can be shown as described in the scale in a range from about 1×10⁸ to about 2×10⁸ N/m². This range represents the frame and reinforcement materials response depending on their elastic modulus, in response to the pressure (2500 to 5000 Pa) applied to the module. That is, materials such as metal (e.g., aluminum and steel), plastics, and polymers with a large elastic modulus, the strain caused by 2500 to 5000 Pa can induce a large stress within the materials. FIG. 2D depicts a panel 210 shown in a compositional fraction map, where 1 represents a pure metal and 0 represents air or space, rather than a stress or pressure map as shown in other figures. In the topological optimization method described herein, one can remove materials based on density-based optimization or by level-set-based optimization. The von Mises stress on the entire frame (rectangular frame +optimization area) is shown in FIG. 2C. FIG. 2D depicts the same information, but only within the optimization area. This is the initial result with no topological optimization. FIG. 2D represents a compositional interpolation, where an intermediate value between 0 and 1 might represent a composite material, for example. In the example shown in FIG. 2D the support structure 204 is purely a metal.

FIG. 2E depicts a panel 212 shows an optimized design for a support structure 204 where areas of the support structure 204 is metal. Because a density-based optimization was used in this example, the quasi-metal-air composite shows metal fraction ranging from 0 to 1 on the scale bar. The range above approximately 0.5 or 0.6, for example, was set as pure metal and anything below as empty space. These are indicated in a portion 214 of the support structure 204 shown. FIG. 2F depicts a panel 216 resulting in the indication of metal as shown in in the portion 214 from FIG. 2E. FIG. 2G depicts a panel 218 having a frame 202 and included support structure 204, where a portion 220 of the support structure represents the resulting portion 220 where a metal frame would provide the most advantageous and optimized reinforcement of the panel 218. Again, because density-based optimization is used in this example, the quasi-metal-air composite shows metal fraction ranging from 0 to 1 on the scale bar. FIG. 2H depicts a panel 222 where the frame 202 includes a support structure 220 based on the preceding topological optimization. The analysis begins with an initial structure 204 for optimization for a given condition. The initial design (FIG. 2B) of the support structure 204 is the optimization area. The density based topological optimization is used to minimize the total elastic strain energy, while reducing the amount of material used in the optimization area. FIG. 2G further shows the converged optimization result which shows the optimal design as a mixture of air and aluminum. Since such a mixture does not exist, a value of about 0.3 is used as a filter to determine if the optimized area will be aluminum or air. FIG. 2H shows the resulting aluminum material after the optimization and filtering. This would be used to fabricate a real frame.

The pressure values are obtained from wind speed values and the resulting pressure on solar panels and frames. The 5000 Pa value is based off the maximum possible wind speed. Other data is derived from experimental measurements. The frame material used in the simulation was aluminum and acrylic plastic, which are commonly used for solar panel framing. The dimensions were based off of commercially used solar panel frames. The maximum possible pressure due to wind was used for design considerations.

As with similar topological optimization methods, the problem is defined, usually starting with a 2D or a 3D model of the design space, defining the loads and constraints, and specifying the objective function. The design domain can then be divided into a mesh of elements, where each element can be assigned a material density value (e.g., 0 for no material, 1 for full material). An optimization algorithm can then be utilized to iteratively adjust the material densities of the elements, while satisfying the constraints and minimizing the objective function. The design can be refined and improved as needed. As a result, topology optimization can enable the exploration of a wide range of design possibilities and the discovery of solutions that might not be obvious through traditional design methods.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

Aspects of the present disclosure include where the present disclosure provides a reinforcement frame, comprising a modular frame having one or more supporting structural beams (e.g., rectangular frame), and a topologically optimized reinforcement portion intersecting with the one or more supporting structural beams. The reinforcement frame can include wherein the modular frame further comprises a metal, a metal alloy, or a combination thereof. The reinforcement frame can include, wherein the modular frame further comprises aluminum or steel. In examples, the reinforcement frame has a modular frame that further comprises a material having a glass transition temperature equal or greater to about 100° C. The reinforcement frame can include where the modular frame further includes a polymer, a fiber-reinforced polymer or a combination thereof. The reinforcement frame can include wherein the topologically optimized reinforcement portion further comprises a metal, a metal alloy, or a combination thereof. The reinforcement frame can include wherein the topologically optimized reinforcement portion further comprises a polymer, a fiber-reinforced polymer or a combination thereof. The reinforcement frame can include wherein the topologically optimized reinforcement portion further comprises a material having high emissivity in a mid-infrared range. In examples, the topologically optimized reinforcement portion further includes a material having a glass transition temperature equal or greater to about 100° C.

The present disclosure provides a method of optimizing a module frame reinforcement, including creating a topological map of a reinforcement in a module frame, determining one or more pressure values over the topological map at a prescribed load, optimizing one or more locations in the reinforcement corresponding to the one or more pressure values, and redesigning the reinforcement to incorporate support in the one or more locations in the reinforcement corresponding to the one or more pressure values in a topologically optimized module frame. The method includes wherein the prescribed load is 2400 Pa. The prescribed load can reach 5000 Pa to simulate extreme weather conditions. The method further includes the step of fabricating a topologically optimized module frame or incorporating the topologically optimized module frame into a photovoltaic module. In examples, the method includes wherein the topologically optimized module frame includes a polymer, a fiber-reinforced polymer or a combination thereof. Injection molding a topologically optimized module frame can be included in this method. The topologically optimized module frame can include a polymer, a fiber-reinforced polymer or a combination thereof. The topologically optimized module frame can alternately include a metal, a metal alloy, or a combination thereof, such as aluminum and steel. The method can include the use of 3D printing a topologically optimized module frame, in some examples, where the topologically optimized module frame is comprised of a polymer, a fiber-reinforced polymer or a combination thereof.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A reinforcement frame, comprising:
a modular frame having one or more supporting structural beams; and
a topologically optimized reinforcement portion intersecting with the one or more supporting structural beams.

2. The reinforcement frame of claim 1, wherein the modular frame further comprises a metal, a metal alloy, or a combination thereof.

3. The reinforcement frame of claim 2, wherein the modular frame further comprises aluminum, steel or a combination thereof.

4. The reinforcement frame of claim 1, wherein the modular frame further comprises a material having a glass transition temperature equal or greater to about 100° C.

5. The reinforcement frame of claim 1, wherein the modular frame further comprises a polymer, a fiber-reinforced polymer or a combination thereof.

6. The reinforcement frame of claim 1, wherein the topologically optimized reinforcement portion further comprises a metal, a metal alloy, or a combination thereof.

7. The reinforcement frame of claim 1, wherein the topologically optimized reinforcement portion further comprises a polymer, a fiber-reinforced polymer or a combination thereof.

8. The reinforcement frame of claim 1, wherein the topologically optimized reinforcement portion further comprises a material having high emissivity in a mid-infrared range.

9. The reinforcement frame of claim 1, wherein the topologically optimized reinforcement portion further comprises a material having a glass transition temperature equal or greater to about 100° C.

10. A method of optimizing a module frame reinforcement, comprising:
creating a topological map of a reinforcement in a module frame;
determining one or more pressure values over the topological map at a prescribed load;
optimizing one or more locations in the reinforcement corresponding to the one or more pressure values; and
redesigning the reinforcement to incorporate support in the one or more locations in the reinforcement corresponding to the one or more pressure values in a topologically optimized module frame.

11. The method of claim 10, wherein the prescribed load is 2400 Pa.

12. The method of claim 10, wherein the prescribed load is 5000 Pa.

13. The method of claim 10, further comprising fabricating a topologically optimized module frame.

14. The method of claim 13, further comprising incorporating the topologically optimized module frame into a photovoltaic module.

15. The method of claim 13, wherein the topologically optimized module frame is comprised of a polymer, a fiber-reinforced polymer or a combination thereof.

16. The method of claim 10, further comprising injection molding a topologically optimized module frame.

17. The method of claim 16, wherein the topologically optimized module frame is comprised of a polymer, a fiber-reinforced polymer or a combination thereof.

18. The method of claim 10, wherein the topologically optimized module frame is comprised of a metal, a metal alloy, or a combination thereof.

19. The method of claim 10, further comprising 3D printing a topologically optimized module frame.

20. The method of claim 19, wherein the topologically optimized module frame is comprised of a polymer, a fiber-reinforced polymer or a combination thereof.
